(19) United States
(12) Patent Application Publication
(10) Pub. No.: US 2022/0076009 A1
(43) Pub. Date: Mar. 10, 2022

(54) METHODS AND SYSTEMS OF RESUME BUILDER FEEDBACK MODULES

(71) Applicants: SALIL PANDE, palo alto, CA (US); kiran MISHRA PANDE, palo alto, CA (US)

(72) Inventors: SALIL PANDE, palo alto, CA (US); kiran MISHRA PANDE, palo alto, CA (US)

(21) Appl. No.: 16/997,779

(22) Filed: Aug. 19, 2020

Related U.S. Application Data
(60) Provisional application No. 62/888,792, filed on Aug. 19, 2019.

(51) Int. Cl. G06K 9/00; G06F 40/166; G06Q 10/10

(52) U.S. Cl. CPC G06K 9/00463; G06Q 10/1053; G06F 40/166; G06K 9/00469

(57) ABSTRACT

A computer-implemented method comprising: detecting that a user focuses on a text area to edit; fetching a corresponding feedback from a feedback object; based on the feedback show a suggested feedback; determine that the element is an essential element; with a tracker functionality, displaying with an indicator for each tracker; adding more content by displaying an additional material; adding more content step by opening a tool on the right side in synchronization with an editing panel; displaying category suggestions when a section has no sub section type structure; and enabling a suggestions API to directly access from a categories server.

### CLAIM OF PRIORITY

This application claims priority to U.S. Provisional Patent Application No. 62/888,792, filed on Aug. 19, 2019 and titled METHODS AND SYSTEMS OF RESUME BUILDER FEEDBACK MODULES. This provisional application is hereby incorporated in its entirety.

### BACKGROUND

Current methods of helping users in their career journey rely heavily on human intervention, whether it is in the form of a career coach, resume writer, own personal network, etc. There are no platforms that leverage data analytics to give the consumer objective guidance on a) what they need in light of their career goals b) what their career goals should be based on their own unique profile. The invention aims to provide a data analytics-based system that helps candidates make better decisions about their careers regardless of the career they are in.

On the companies side, there are limited methods that attempt to remove bias in the recruitment process, while capturing the unique requirements each company inherently has for a job role. In today's world Application Tracking Systems and other mechanisms simply use a set of keywords to filter through candidates, creating a very binary phenomenon of candidate selection. Whereas candidate selection is inherently a spectrum some candidates are a better fit for some jobs than others. The invention aims to build an automated system/mechanism to objectively, effectively, and efficiently simplify the recruiting process while taking care of the inherent customizations and complexity in it. It emulates the behavior and assessment of human mind works.

### BRIEF SUMMARY OF THE INVENTION

A computer-implemented method comprising: detecting that a user focuses on a text area to edit; fetching a corresponding feedback from a feedback object; based on the feedback show a suggested feedback; determine that the element is an essential element; with a tracker functionality, displaying with an indicator for each tracker; adding more content by displaying an additional material; adding more content step by opening a tool on the right side in synchronization with an editing panel; displaying category suggestions when a section has no sub section type structure; and enabling a suggestions API to directly access from a categories server.

### BRIEF DESCRIPTION OF THE DRAWINGS

FIG. 1 illustrates an example process for implementing resume builder feedback modules, according to some embodiments.

FIG. 2 illustrates an example process for implementing a Suggestions/Bullet Feedback/Tracker, according to some embodiments.

FIG. 3 illustrates an example screen shot of frontend elements, according to some embodiments.

FIG. 4 illustrates an example screen shot of navigation bars in a resume builder application, according to some embodiments.

FIG. 5 illustrates an example set of API's for implementing resume builder feedback, according to some embodiments.

FIG. 6 depicts an exemplary computing system that can be configured to perform any one of the processes provided herein.

The Figures described above are a representative set and are not an exhaustive with respect to embodying the invention.

### DESCRIPTION

Disclosed are a system, method, and article of resume builder feedback modules. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application can be a computer program designed to perform a group of coordinated functions, tasks and/or activities for the benefit of the user.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Deep learning can use machine learning methods based on learning data representations (as opposed to task-specific algorithms). Deep learning can be supervised, semi-supervised or unsupervised. Deep learning architectures can include, inter alia: deep neural networks, deep belief networks, recurrent neural networks, etc.

Intelligent virtual assistant (IVA) (and/or intelligent personal assistant (IPA)) is a software agent that can perform tasks or services for an individual based on verbal commands.

Machine learning is a type of artificial intelligence (AI) that provides computers with the ability to learn without being explicitly programmed. Machine learning focuses on the development of computer programs that can teach themselves to grow and change when exposed to new data.

Natural language processing (NLP) is a subfield of computer science, information engineering, and artificial intelligence concerned with the interactions between computers and human (natural) languages, in particular how to program computers to process and analyze large amounts of natural language data.

Recommendation system can be a subclass of information filtering system that seeks to predict the ‘rating’ or ‘preference’ that a user would give to an item.

Recurrent neural network (RNN) is a class of artificial neural network where connections between nodes form a directed graph along a sequence. This allows it to exhibit temporal dynamic behavior for a time sequence. Unlike feedforward neural networks, RNNs can use their internal state (memory) to process sequences of inputs.

Speech recognition is the inter-disciplinary sub-field of computational linguistics that develops methodologies and technologies that enables the recognition and translation of spoken language into text by computers. Speech recognition can include automatic speech recognition (ASR), computer speech recognition and speech to text (STT).

### Example Methods

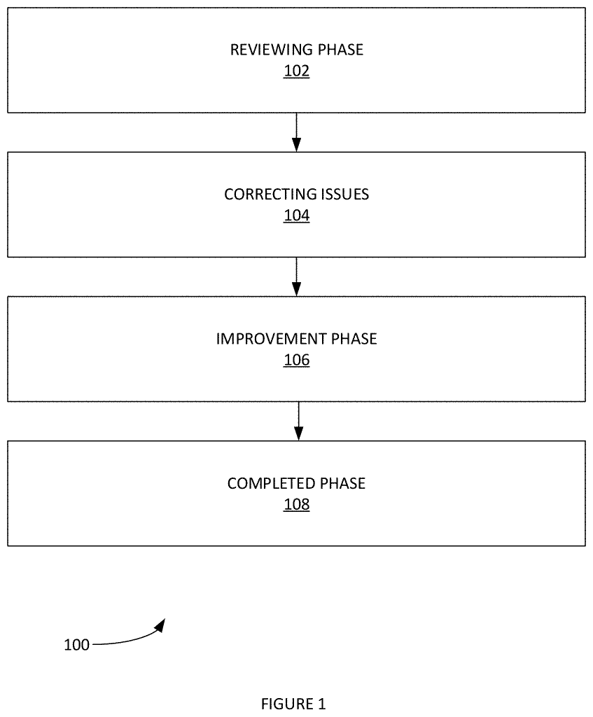

FIG. 1 illustrates an example process 100 for implementing resume builder feedback modules, according to some embodiments. In step 102, process 100 can implement a reviewing phase where user reviews the text identification. In step 102, conversion types 0/1 are highlighted in red or yellow on a digital image of the user's resume. Once the user modifies any field, the highlighting is then removed. Entity feedback can also be fetched whenever any edit is happening so that next step has data available immediately for it. The user also has the ability to add/delete/move up/move down sections or subsections.

In step 104, process 100 can implement a correcting issues phase where user corrects any presentation issues. Any missing essential entities are highlighted. All elements which have at least one failed p-checks can be highlighted as well. For example, this can include, inter alia: GPA, period check, etc. When the user clicks on any section, the section is brought to the top and the important message (e.g. such as what p-check an element is failing) is shown right under the editing area. Additionally, depending the subsection the user is reviewing, the relevant tracker is shown. The relevant tracker includes what elements are to be written in the subsection and status of each element.

In step 106, process 100 implement improvement phase where all the content improvement steps are shown. In step 106, feedback is fetched. Process 100 loads a user-interface screen in a personal assistant application and said screen is shown. Page height can be checked on a periodic basis (e.g. every 3 seconds) to determine if it crossed the limit and a notification via a red bar on the right side in personal assistant can be displayed. Once the user reaches this step, this can be stored in a backend serve. In this way, the next time a user opens the URL, the steps 102 and 104 can be skipped. The user is directly brought to the improvement step 106.

Process 100 can be run whenever feedback and/or wordcount is being modified to check which sections are completed and which are not. A section is considered completed when it has required a word count and no red/yellow bullets are extant (e.g. if bullet structure is required for the section).

As noted supra, process 100 can be implemented with a virtual personal assistant functionality. The virtual personal assistant panel can be divided into two categories on the right: completed steps and remaining steps. First section of remaining step is shown by default. User can click on any section, not the order we show him. Depending on which section the user clicks on, the corresponding step is auto opened. Word count can be continuously calculated whenever the user is editing and red bullets count is calculated whenever entity-feedback is updated. When a step is in the incomplete bucket and it completes the requirements, a fade text display indicating the completeness (e.g. a text of “good job”, etc.) and that the step is completed is shown on the right side to notify user. It is noted that if a user is creating a resume from scratch, the user is directly taken to step 106.

In step 108, process 100 can implement a completed phase where user can continue editing but process 100 disables the feedback. Process 100 shows the user a graph with feedback and/or other relevant resume information and/or various modules scores. The user can continue editing. In one example, no feedback is fetched in this step. The user has access to all toolbars to add/delete/move section or subsections. The progress can be updated at specified intervals (e.g. every 60 seconds, etc.).

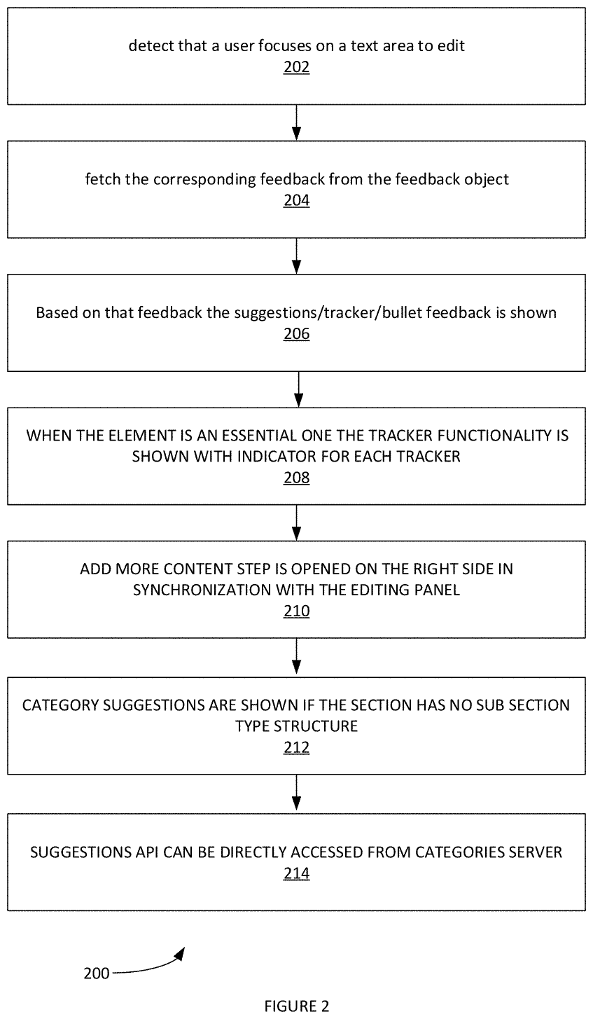

FIG. 2 illustrates an example process 200 for implementing a Suggestions/Bullet Feedback/Tracker, according to some embodiments. In step 202, process 200 can detect that a user focuses on a text area to edit (e.g. and/or clicks on text area and edit view is open). Process 200 can then fetch the corresponding feedback from the feedback object in step 204. Based on that feedback the suggestions/tracker/bullet feedback is shown in step 206.

When the element is an essential one (e.g. location/date/position/degree, etc.) the tracker functionality (e.g. ‘Things to Write’, etc.) is shown with indicator for each tracker in step 208. In other examples, process 200 can display additional material. For example, when the element is a bullet, process 200 displays the user suggestions and/or bullet feedback depending on the whether the bullet is newly added or not. When a new bullet is added, process 200 uses a key ‘isNew’ to identify it as a new bullet and show new content suggestions for the bullet instead of bullet feedback. Either categories suggestions or skills suggestions are shown based on the section type. Along with skills/categories, the bullet structure tracker (e.g. AO, specifics, avoided and bullet length) is also shown, which are not clickable here (e.g. detailed suggestions are not shown until the full bullet is entered).

In step 210, process 200 can add more content step is opened on the right side in synchronization with the editing panel. Whenever the user moves to another bullet or closes the edit view, process 200 sets isNew to false. Bullet feedback can be shown in case of already entered bullets. It is divided into four categories—action, specifics, overused and bullet length. If user edits and we fetch entity feedback after a pause, process 200 shows a loading wave to indicate the user. It is stored using a fetching key. Since new content suggestions are shown for new bullet, bullet feedback is included in a minor area containing just four module names (e.g. action, specifics, etc.), each along with status (e.g. red or green (not detailed feedback), etc.).

In step 212, category suggestions are shown if the section has no sub section type structure. Once the user enters a new bullet, the suggestions are refreshed, removing any categories he has already written. The loading panel is shown for categories during this time. When a user adds new bullet during this time, the suggestions update is not called again.

Suggestions API can be directly accessed from categories server in step 214. Accordingly, skills suggestions are shown for section with subsection type structure. The suggestions are updated whenever a user adds a new bullet to show new suggestions. While skills suggestions are being fetched, if a user adds new bullet during this time, the skills suggestions API is not called again. The API can be directly accessed from skills server.

### Example Screenshots

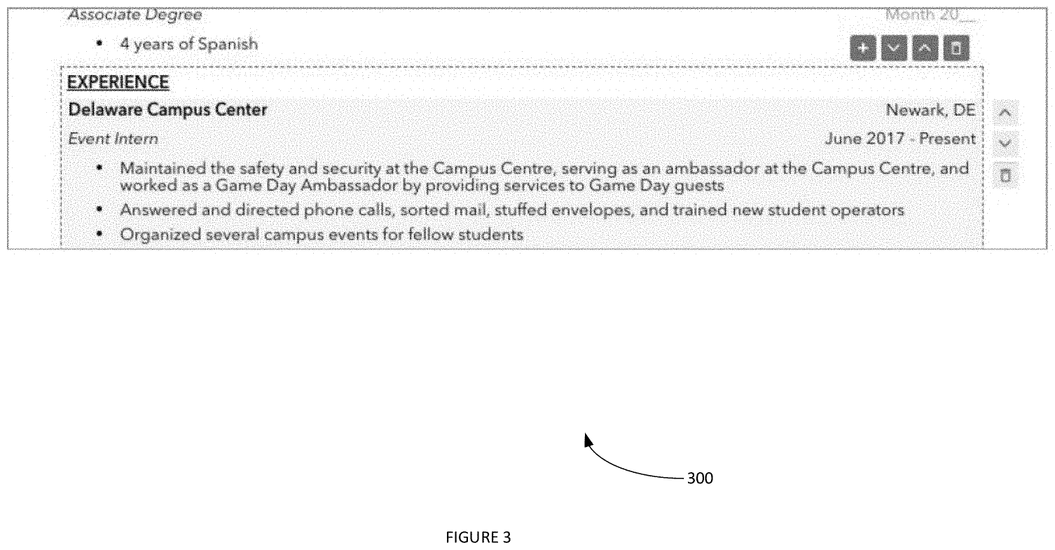

Process 100 and 200 can be utilized in a resume builder application. FIG. 3 illustrates an example screen shot 300 of frontend elements of interface of a resume building application, according to some embodiments. Resume building toolbars can be provided. This can be shown in reviewing step 102, improvement step 104 and completed phase 108. Two types of toolbars can be provided. One toolbar can be provided at section level. This toolbar appears above the section on hover and the other at subsection level. A section level toolbar contains options to add a subsection (e.g. disabled if not a subsection type section), move the section up or down (e.g. disabled if section is first or last) and option to delete the section. A delete option can be disabled for essential sections. A sub-section level toolbar contains options to move up/down (disabled if first or last subsection) and delete entity (disabled if only one subsection is present).

Resume builder application can provide navigation bars (e.g. ‘navbars’, etc.). Resume builder application can provide two navbars. A first navar can be provided at the top and a second navbar can be provided at the left-side (e.g. both can always be presented). A top navbar shows which step the user is in (e.g. reviewing, presentation or improvement, etc.) along with option to download resume at any time. A side navbar contains the scoring info and the button to upload back to resume product. User can have at least one upload remaining e.g. (also validated in the backend) and can be used to enter an alphanumeric file name before uploading to the resume product.

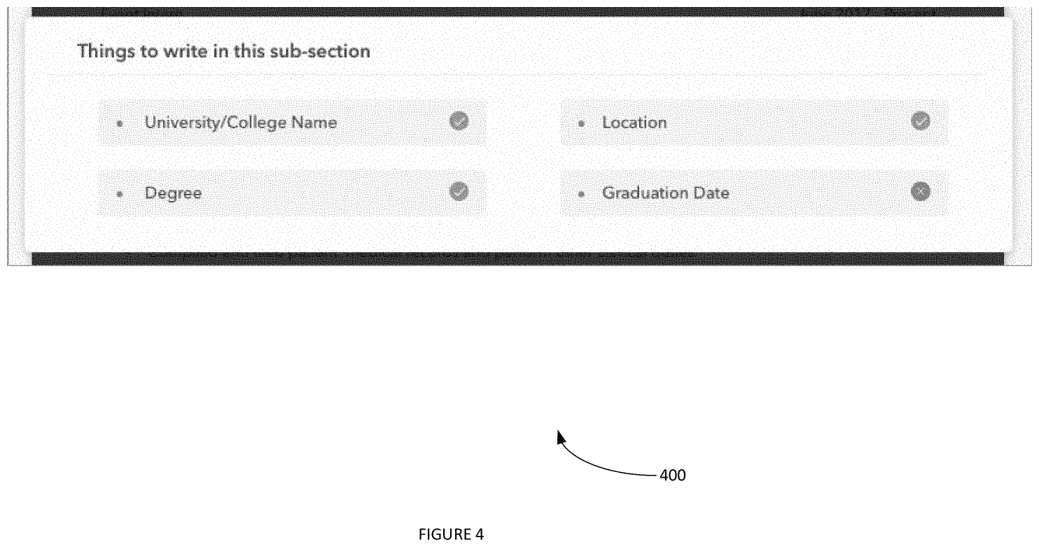

FIG. 4 illustrates an example screen shot of a tracker functionality with suggestions and bullet point feedback in a resume builder application, according to some embodiments. A tracker can determine what essential elements to be written in subsection along with the status green or red depending on the status type. While entity feedback is being fetched for any essential element, a loading wave icon is shown to the user. Suggestions can show skills and/or categories suggestions depending on whether a section has subsection type structure or not. Bullet feedback can be provided. Bullet feedback can be provided with four impact module (e.g. impact, specifics, avoided and bullet length, etc.) are shown. This can be done when feedback is present.

### Example APIs

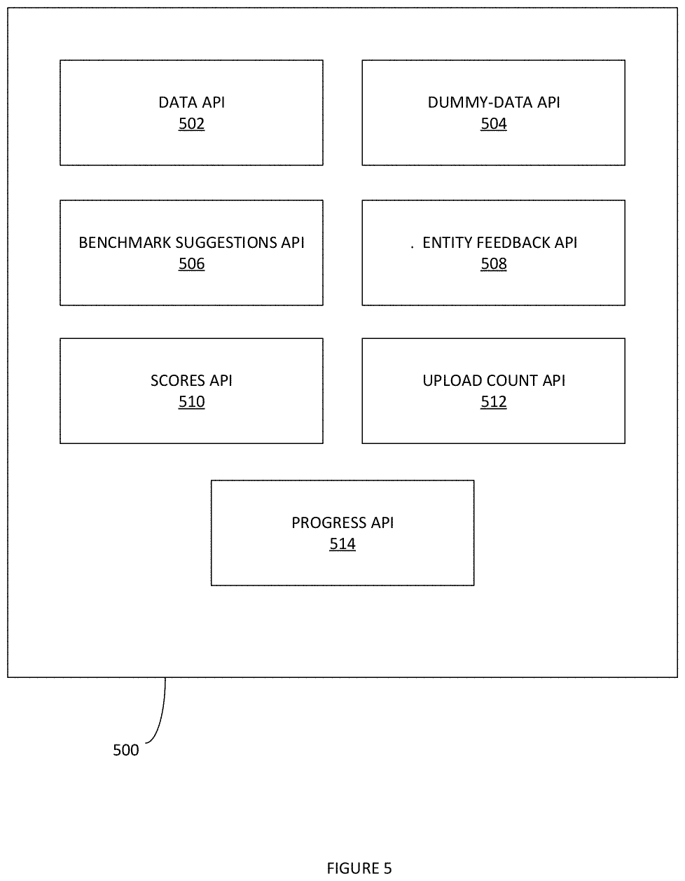

FIG. 5 illustrates an example set of API's 500 for implementing resume builder feedback, according to some embodiments.

Data can be fetched from data API 502 (e.g. implement data parser a full feedback). Data API 502 accesses personal information split into various individual entities. All sections can be identified, along with what type they are. These can include entities and/or sub sections and/or just bullets and/or a paragraph section. Data API 502 accesses essential entities for each section, elements that need to be present in a section (e.g. date, location, company and position for experience section). Data API 502 can provide a list of bullets in each section, categorized into subsections/entities depending on the section type—Each element has a conversion type, 0/1/2, 0 being unidentified text and 1 being identified text that needs review—Each element has a status type, 0/1/2, 0 being the element is in status red and 2 being element is status green.

Dummy-data API 504 can fetch dummy data. Dummy-data API 504 can contain dummy data for different types of sections such as entities section, bullets section, etc. Dummy-data API 504 can provide possible sections for each type of section. Dummy-data API can provide a default category suggestions for each section. Dummy-data API can provide essential entities for each section. Dummy-data API can provide improvement steps to be shown e.g. (bullet structure and add more content) along with word count cutoffs for each section. Dummy-data API can be used to add any section or subsection without hitting backend.

Benchmark suggestions API 506 can provide default skills suggestions. Benchmark suggestions API 506 can Fetched once before improvement step, they are shown by default to any new sections with subsection type structure are added, or if any subsections are added in already present sections. Entity feedback can be for a particular field (e.g. location/bullet, etc.). Entity feedback can contain the type it is (e.g. 0 being not matching and 2 being correct), any p-checks that element is failing along with spell check. Entity feedback API 508 can be for bullets, impact feedback (e.g. action, specifics, avoided overused, bullet length) can be included as well. This is fetched when user gives a one second pause while writing. If a second pause occurs while first API call is still in progress, the first API call is aborted. Scores API 510 can be fetched once under data API. The user then has the option to manually refresh the scores using the nav bar on the left side. The button to refresh scores is disabled if the refresh is in progress. The time when the scores are last refreshed can be shown to the user. An upload count API 512 can be fetched at a periodic interval (e.g. every 30 seconds, etc.). The user can be shown how many uploads to resume product are remaining. The user's progress can be fetched once as part of feedback when entering improvement step. After this, it can be refreshed at another specified interval (e.g. every 60 seconds via the progress API 514).

Additional Systems and Architecture

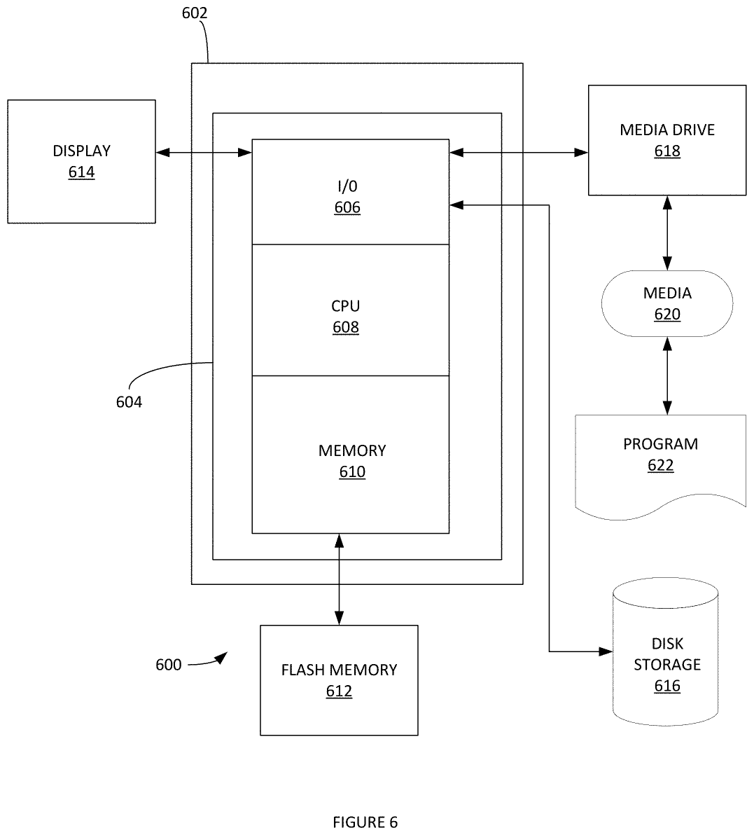

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method comprising:
detecting that a user focuses on a text area to edit;
fetching a corresponding feedback from a feedback object;
based on the feedback show a suggested feedback;
determine that the element is an essential element;
with a tracker functionality, displaying with an indicator for each tracker;
adding more content by displaying an additional material;
adding more content step by opening a tool on the right side in synchronization with an editing panel;
displaying category suggestions when a section has no sub section type structure; and
enabling a suggestions API to directly access from a categories server.
